(19) United States
(12) Patent Application Publication
(10) Pub. No.: US 2006/0289042 A1
(43) Pub. Date: Dec. 28, 2006

(54) Cleaning tool

(75) Inventors: Tatsuya Satoyoshi, Shatin (HK); Morihiro Ohno, Shatin (HK); Kazumasa Kitamura, Ichinomiya-city (JP); Tomoki Nagae, Nagoya-city (JP); Shinya Yoshida, Nagoya-city (JP)

Correspondence Address: BURR & BROWN, PO BOX 7068, SYRACUSE, NY, 13261-7068, US

(73) Assignees: SAE Magnetics (H.K.) Ltd., Shatin (HK); NGK Insulators, Ltd., Nagoya-City (JP)

(21) Appl. No.: 11/475,555

(22) Filed: Jun. 27, 2006

(30) Foreign Application Priority Data
Jun. 27, 2005 (JP) 2005-186483

(51) Int. Cl. B08B 3/04

(52) U.S. Cl. 134/135; 134/137; 134/201

(57) ABSTRACT

A cleaning tool has a tray 10 and a cover member 20. The tray has a space for individually accommodating a to-be-cleaned object D. The cover member has a frame 21, and thread-like members 22 and 23. The thread-like members 22 are tensioned to the frame along a first direction so as to form a first plane section that defines the top portion of the space. The thread-like members 23 are tensioned to the frame along a second direction so as to form a second plane section above the first plane section. When the thread-like members 22 are about to vibrate during the cleaning, the thread-like members 22 are about to vibrate during the cleaning, member can relatively freely move in each plane section.

### BACKGROUND OF THE INVENTION

1. Field of the Invention

The present invention relates to a cleaning tool that has a space for accommodating a to-be-cleaned object, and is dipped into cleaning solution with the to-be-cleaned object accommodated into the aforesaid space in order to clean the to-be-cleaned object.

2. Description of the Related Art

A device made mainly of ceramics or the like is manufactured, for example, by cutting a member, which is formed integrally from above-mentioned plural devices, into individual pieces during a cutting process. Resins used for fixing the member to the cutting jig during the cutting process as well as powders (fine chips) produced by the cut of the member are adhered onto the device. Therefore, the device should be cleaned by an ultrasonic cleaning method etc. after the cutting process.

Such a conventional cleaning tool for cleaning the device is provided with a tray having at least a top face that is open and having a space slightly greater than the device that is a to-be-cleaned object, and a cover member to be arranged on the top surface of the space. The cover member has a mesh section. The device accommodated in the space defined by the tray and the cover member of the cleaning tool is dipped in cleaning solution in a cleaning tank with the cleaning tool, whereby ultrasonic wave is applied thereto via the cleaning solution. The cover member having the mesh section can be composed of a frame and a net supported by the frame. This net is composed of warp threads and woof threads braided so as to be over and under each other, as shown by a partially enlarged view in FIG. 33.

However, as shown in FIG. 34, a net 101 of a cover member 100 greatly vibrates during the cleaning, with the result that the volume of the space SP (the height of the space SP) into which the device D is accommodated may be increased. This state may cause the device D to come out from the space SP that accommodates the device D. When a rigidity of the thread is enhanced by increasing the tension of each thread or by increasing the number of portions where warp threads restrict movement of the woof threads and vice versa (e.g., by making the mesh finer and tighter), the warp threads and woof threads cannot move in the plane of the net composed of these threads. Accordingly, the warp threads and woof threads become obstructions which prevent the cleaning solution or the ultrasonic wave from reaching the device D. As a result, a problem of insufficient cleaning for the device D arises.

### SUMMARY OF THE INVENTION

A cleaning tool according to the present invention is accomplished in view of the foregoing subject, and the cleaning tool comprises;

a tray having formed thereto (a tray having and forming) a space for individually accommodating a to-be-cleaned object (to-be-cleaned object accommodating space), wherein at least the top portion of the space is open; and

a cover member including a frame, a first plane section made of (or composed of) plural thread-like members that are strained against (or tensioned to) the frame along a predetermined first direction so as to form (compose) one plane section, a second plane section made of (or composed of) plural thread-like members that are strained against (or tensioned to) the frame along a second direction crossing the first direction so as to form (or compose) another plane section that is parallel to the first plane section and is proximate to the first plane section above the first plane section or a second plane section made of (or composed of) bar-like members supported by the frame along the second direction crossing the first direction so as to form (compose) the same another plane section, wherein the first plane section defines the top surface of the space when the cover member is set on (or arranged above) the tray, wherein the cleaning tool is dipped into cleaning solution with the to-be-cleaned object accommodated in the space.

According to this invention, each of the to-be-cleaned objects is dipped into cleaning solution with the cleaning tool when (in a state where) each of them is individually accommodated in the space (to-be-cleaned object accommodating space) defined by the tray and the first plane section of the cover member, whereby each of the objects is cleaned by an ultrasonic cleaning method or the like. The top surface of the space for accommodating the to-be-cleaned object is defined by the first plane section. The first plane section is made of (or composed of) plural thread-like members strained against (or tensioned to) the frame along the predetermined first direction so as to form one plane section. Further, the frame has “plural thread-like members strained against (or tensioned to) the frame” along the second direction crossing the first direction or “bar-like members supported by the frame” along the second direction, as to form the second plane section that Is another plane section parallel to the first plane section and proximate to the first plane section above the first plane section.

Specifically, “the plural thread-like members constituting the second plane section” or “the bar-like members constituting the second plane section” are arranged immediately above (set directly on) the plural thread-like members constituting the first plane section, and arranged so as to cross the thread-like members constituting the first plane section in a plan view. Therefore, when the thread-like members constituting the first plane section is about to vibrate with both end portions (base portions of the tension) as a node, the thread-like members or bar-like members constituting the second plane section hold down the thread-like members constituting the first plane section so as to restrict the vibration. As a result, the possibility of the to-be-cleaned object coming out of the to-be-cleaned object accommodating space and falling off from the cleaning tool during the cleaning can be reduced.

On the other hand, the thread-like members or bar-like members constituting the second plane section are arranged above the thread-like members constituting the first plane section, and therefore, do not restrict the movement of the thread-like members constituting the first plane section in the plane parallel to the first plane section. Thus, the thread-like members constituting the first plane section can move in the plane parallel to the first plane section when the cleaning solution comes in or out of the space, so that they do not obstruct the arrival of the cleaning solution (or the ultrasonic wave) to the to-be-cleaned object. Consequently, the possibility of the arrival of the cleaning solution (or ultrasonic wave) to the whole surface of the to-be-cleaned object is increased, whereby the to-be-cleaned object can sufficiently be cleaned.

The cleaning tool preferably has plural thread-like members that are placed (arranged) between the top surface of the portion forming (composing) the lower section (bottom section) of the space of the tray and the lower surface of the first plane section of the cover member for maintaining the gap (hereinafter referred to as “height of the space”) between the top surface of the portion composing the lower section of the space and the lower surface of the first plane section.

According to this configuration, the height of the space can easily be changed only by replacing the thread-like members arranged between the top surface of the portion forming the lower section (bottom section) of the space of the tray and the lower surface of the first plane section with thread-like members having different diameters. Accordingly, a cleaning member (or a cleaning tool) that can be used for to-be-cleaned members having various heights can easily be provided.

Another cleaning tool according to the present invention comprises:

a tray a tray having and forming (or having formed thereto) a space for individually accommodating a to-be-cleaned object, wherein at least the top portion of the space is open; and

a cover member including a frame, a first plane section made (or composed) of plural thread-like members that are strained against (or tensioned to) the frame along a predetermined first direction so as to form (or compose) one plane section, wherein the first plane section defines the top portion of the space when the cover member is set on the tray (or by the arrangement of the cover member above the tray),

the cleaning tool being dipped into cleaning solution with the to-be-cleaned object accommodated in the space,

wherein the cleaning tool is dipped into cleaning solution with the to-be-cleaned object accommodated in the space, wherein the cover member comprises a bar-like member fixed to the frame so as to extend in a second direction that is parallel to the first plane section and that crosses the first direction above the first plane section and at least in the vicinity of both end portions of the thread-like members, the bar-like member being brought into contact with the thread-like members to apply thereto force in the direction crossing the first plane section (e.g., the force in the direction orthogonal to the first plane section, i.e., the force in the direction that is orthogonal to the plane formed by the frame), thereby applying tension to the thread-like members.

According to this configuration, tension can easily be applied to the thread-like members forming the first plane by the bar-like member. Therefore, it is unnecessary to apply appropriate tension to the thread-like members forming the first plane section when the thread-like members forming the first plane section are mounted (or fixed) to the frame. Thus, the work operation for forming (or making) the cover member can be simplified. Further, tension can surely be applied to the thread-like members, whereby the vibration of the thread-like members during the cleaning can be reduced.

It is noted that, in the above case, the frame may have not only the thread-like members constituting the first plane section but also the above-mentioned thread-like members constituting the second plane section. With this configuration, the bar-like member can apply tension to the thread-like members forming the first plane section and the thread-like members forming the second plane section by exerting force in the direction crossing the first plane section onto the thread-like members forming the first plane section and the thread-like members forming the second plane section.

Moreover, in this case, the cover member preferably has a spring-like member that is engaged with both the bar-like member and the tray when the cover member is set on the tray, the spring-like member exerting force in the direction in which the bar-like member and the tray are made closer to each other.

With this configuration, even if warp of the tray occurs, the warp of the tray can be corrected by the bar-like member and the spring-like member. Therefore, a cleaning tool having the to-be-cleaned object accommodating space which has an aimed size and an aimed shape can be provided.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a plan view of a front surface of a tray constituting a cleaning tool according to a first embodiment of the present invention;

FIG. 2 is a plan view of a back surface of the tray shown in FIG. 1;

FIG. 3 is a side view of the tray shown in FIG. 1;

FIG. 4 is an enlarged plan view of a pattern formed on the tray shown in FIG. 1;

FIG. 5 is an enlarged plan view of the tray cut at a plane along a line 1-1 in FIG. 4;

FIG. 6 is an enlarged plan view of the tray cut at a plane along a line 2-2 in FIG. 4;

FIG. 7 is an enlarged plan view of the tray cut at a plane along a line 3-3 in FIG. 4;

FIG. 8 is a plan view of a cover member constituting the cleaning tool according to the first embodiment of the present invention;

FIG. 9 is a side view of the cover member shown in FIG. 8;

FIG. 10 is a partially enlarged plan view of the cover member shown in FIG. 8;

FIG. 11A is a plan view of the cleaning tool with the cover member shown in FIG. 8 arranged above (or set on) the tray shown in FIG. 1;

FIG. 11B is a side view of the cleaning tool with the same state as FIG. 11A;

FIG. 12 is a partially enlarged plan view of the cleaning tool with the cover member shown in FIG. 8 arranged above (or set on) the tray shown in FIG. 1;

FIG. 13 is a sectional view of the tray and the cover member cut at a plane along a line 4-4 in FIG. 12;

FIG. 14 is a partially enlarged perspective view of the cleaning tool shown in FIG. 12;

FIG. 15 is a view for explaining the operation of the cleaning tool composed of the tray shown in FIG. 1 and the cover member shown in FIG. 8;

FIG. 16 is a plan view of a front surface of a tray constituting a cleaning tool according to a second embodiment of the present invention;

FIG. 17 is an enlarged plan view of a pattern formed on the tray shown in FIG. 16;

FIG. 18 is a sectional view of the tray cut at a plane along a line 5-5 in FIG. 17;

FIG. 19 is a plan view of a cover member constituting the cleaning tool according to the second embodiment of the present invention;

FIG. 20 is a front view of the cover member shown in FIG. 19;

FIG. 21 is a side view of the cover member shown in FIG. 19;

FIG. 22 is a partially enlarged plan view of the cover member shown in FIG. 19;

FIG. 23 is a sectional view of the cover member cut at a plane along a line 6-6 in FIG. 22;

FIG. 24A is a plan view of the cleaning tool with the cover member shown in FIG. 19 arranged above (or set on) the tray shown in FIG. 16;

FIG. 24B is a side view of the cleaning tool with the same state as FIG. 24A;

FIG. 25 is a partially enlarged plan view of the cleaning tool with the cover member shown in FIG. 19 arranged above (or set on) the tray shown in FIG. 16;

FIG. 26 is a sectional view of the tray and the cover member cut at a plane along a line 7-7 in FIG. 25;

FIG. 27 is a view for explaining the operation of the cleaning tool composed of the tray shown in FIG. 16 and the cover member shown in FIG. 19;

FIG. 28 is a sectional view of a cleaning tool according to a modified example of the second embodiment of the present invention;

FIG. 29 is a side view of the cleaning tool shown in FIG. 28;

FIG. 30 is a sectional view of a cleaning tool according to a third embodiment of the present invention;

FIG. 31 is a plan view of a device that is one example of a to-be-cleaned object that Is cleaned by the cleaning tool of the present invention;

FIG. 32 is a front view of the device shown in FIG. 31;

FIG. 33 Is a partially enlarged view of a net of a conventional cleaning tool; and

FIG. 34 is a view for explaining an operation of the conventional cleaning tool.

### DESCRIPTION OF THE PREFERRED EMBODIMENT

Each embodiment of a cleaning tool according to the present invention will be explained hereinafter with reference to drawings.

### First Embodiment

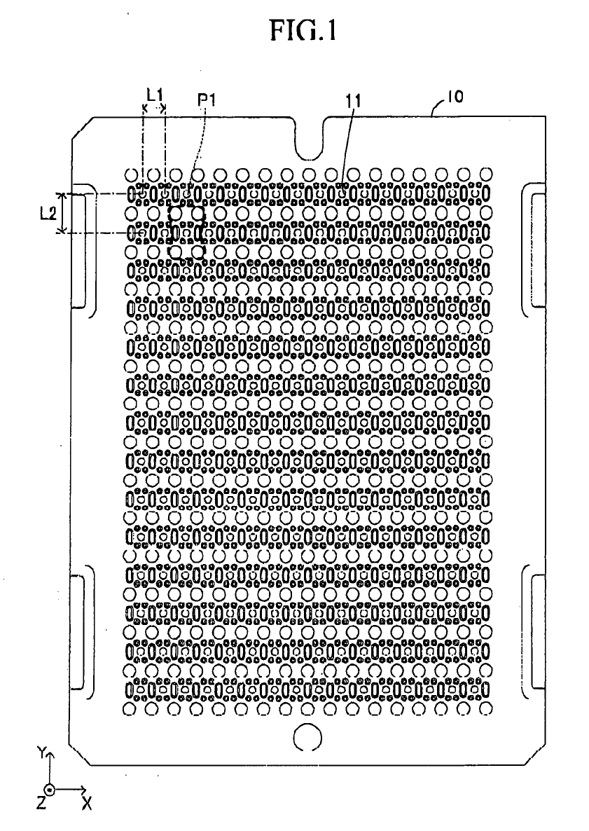

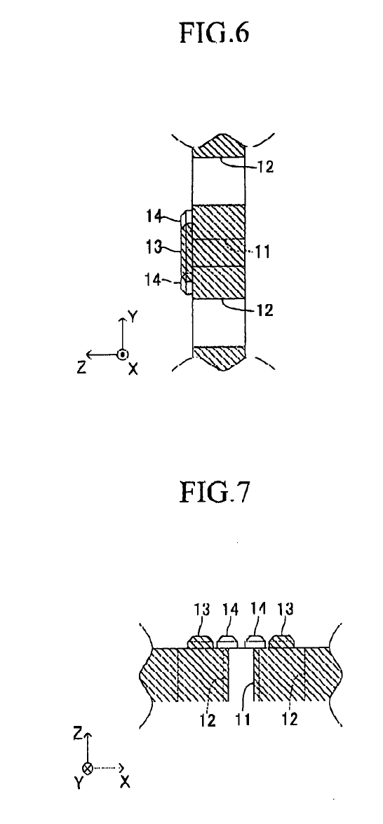

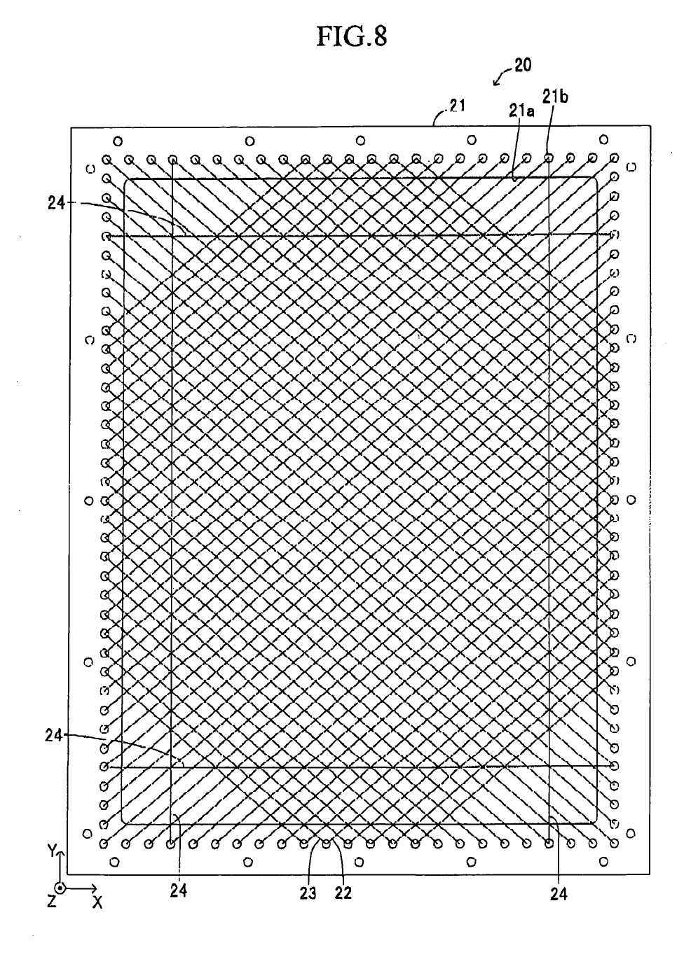

A cleaning tool according to the first embodiment is composed of (or comprises) a tray 10 shown in FIGS. 1 to 7 and a cover member 20 shown in FIGS. 8 to 10.

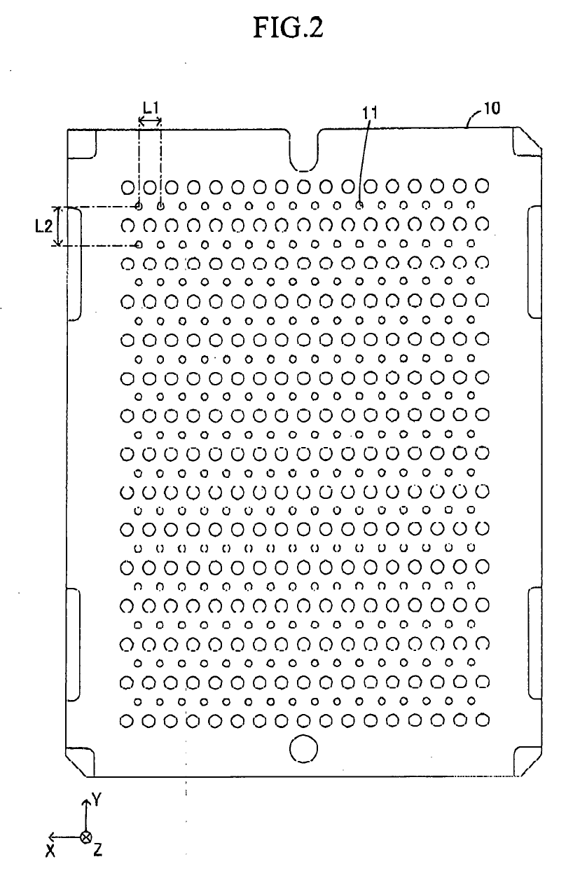

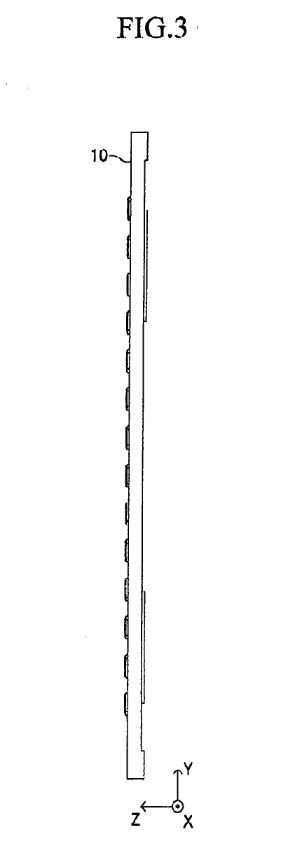

As shown in FIG. 1 that is a plan view of the front surface, FIG. 2 that is a plan view of the back surface, and FIG. 3 that Is a side view, the tray 10 is a generally rectangular thin plate member, in a plan view (or seen from a plane), having sides along an X-axis and sides along a Y-axis, both axes being orthogonal to each other. Patterns P1 encircled by a broken line in FIG. 1 are repeatedly formed at the tray 10 along the X-axis direction and Y-axis direction.

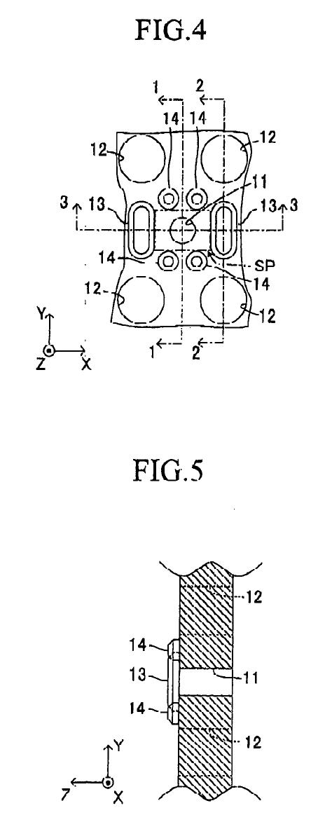

Specifically, the tray 10 has plural through-holes 11, through-holes 12 projections 13 and projections 14 as shown in FIG. 4 that is an enlarged view of the pattern P1, and FIGS. 5, 6 and 7 that are enlarged sectional views of the tray 10 cut at the plane along a line 11, at the plane along a line 2-2, and at the plane along a line 3-3 in FIG. 4, respectively.

The through-hole 11 is formed at every first distance L1 along the X-axis direction, and formed at every second distance L2, which is greater than the first distance, along the Y-axis direction, as shown in FIGS. 1 and 2. The diameter of the through-hole 11 is smaller than the diameter of the through-hole 12. Therefore, the through-hole 11 is referred to as “a small-diameter through-hole 11”, and the through-hole 12 is referred to as “a large-diameter through-hole 12”.

The large-diameter through hole 12 has, in a plan view (or seen from a plane), Its center at the position apart from the center of the small-diameter through-hole 11 by tho distance approximately half the first distance L1 (L1/2) in the X-axis direction, and apart from the center of the small-diameter through-hole 11 by the distance approximately half the second distance L2 (L2/2) in the Y-axis direction. Specifically, the center of the small-diameter through-hole 11 coincides with the intersection of the diagonal line of a virtual rectangle made by linking the centers of the adjacent four large-diameter through-holes 12.

The projection 13 has a shape of ellipse in a plan view (or seen from a plane). Therefore, the projection 13 is referred to as an elliptic projection 13. The minor axis and major axis of the elliptic projection 13 in a plan view (or seen from a plane) are respectively along the X-axis and Y-axis. The center (the intersection of the major axis and minor axis) of the elliptic projection 13 in a plan view (or seen from a plane) coincides with the position apart from the center of the small-diameter through-hole 12 by the distance approximately half the first distance L1 (L1/2) in the X-axis direction. In other words, the elliptic projection 13 is formed between the adjacent two large-diameter through-holes 12 in the Y-axis direction. A taper surface is formed on the top surface of the elliptic projection 13.

The projection 14 has a circular shape in a plan view (or seen from a plane). Therefore, the projection 14 is referred to as a circular projection 14. The center of the circular projection 14 in a plan view (or seen from a plane) is located at the position apart from the center of the small-diameter through-hole 11 by the distance approximately a fifth the first distance L1 (L1/5) in the X-axis direction, and apart from the center of the small-diameter through-hole 11 by the distance approximately a fifth the second distance L2 (L2/5) in the Y-axis direction. Specifically, the center of the small-diameter through-hole 11 coincides with the intersection of the diagonal line of a virtual rectangle made by linking the centers of adjacent four circular projections 14. A taper surface is formed on the top surface of the circular projection 14.

With this configuration, the tray 10 has and forms (or has formed thereto) a space SP (see FIG. 4) that is defined by (or composed of) a pair of elliptic projections 13 opposed to each other across a single so as to surround the small-diameter through-hole 11. The space is for individually accommodating a to-be-cleaned object, wherein at least the upper portion of the space SP is open.

The tray 10 is desirably made of a material that is not adhered to the to-be-cleaned object, even if the tray 10 is brought into contact with the to-be-cleaned object. Since the to-be-cleaned, object in this example is made of ceramics, preferable materials for the tray 10 include polyamide(nylon)-based resin, polyester-based resin, polyurethane-based resin, polyolefin-based resin (polypropylene-based resin, polyethylene-based resin), polyvinyl-chloride-based resin, polyvinylidene-chloride-based resin, polyethylene-fluoride-based rosin polyvinyl-alcohol-based resin, polychlarl-based resin, polyacryl-based resin, and fluorine-based resin. Further, ABS resin polycarbonate and PEEK (polyether ether ketone) can be employed as the material. Moreover, a material having a taper abrasion in accordance with ASTM-D1044 is not more than 300 mg/1000 times is selected for the tray 10.

The cover member 20 is composed of a frame 21, and plural thread-like members 22, 23 and 24.

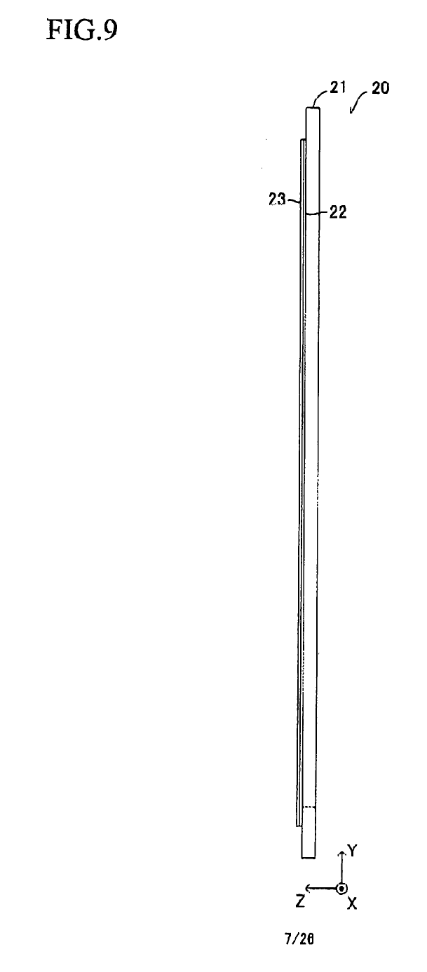

As shown in FIG. 8 that is a plan view and FIG. 9 that is a side view of the cover member 20 the frame 21 is a thin plate member having a rectangular outer shape in a plan view (or seen from a plane). The minor sides and major sides of this rectangle are respectively along the X-axis and Y-axis. A rectangular opening (window) 21a which is slightly greater than the outer shape of the tray 10 is formed at the frame 21. Further, holes 21b for holding (or tying) the thread-like members 22, 23 and 24 are formed at the frame 21 at a constant interval.

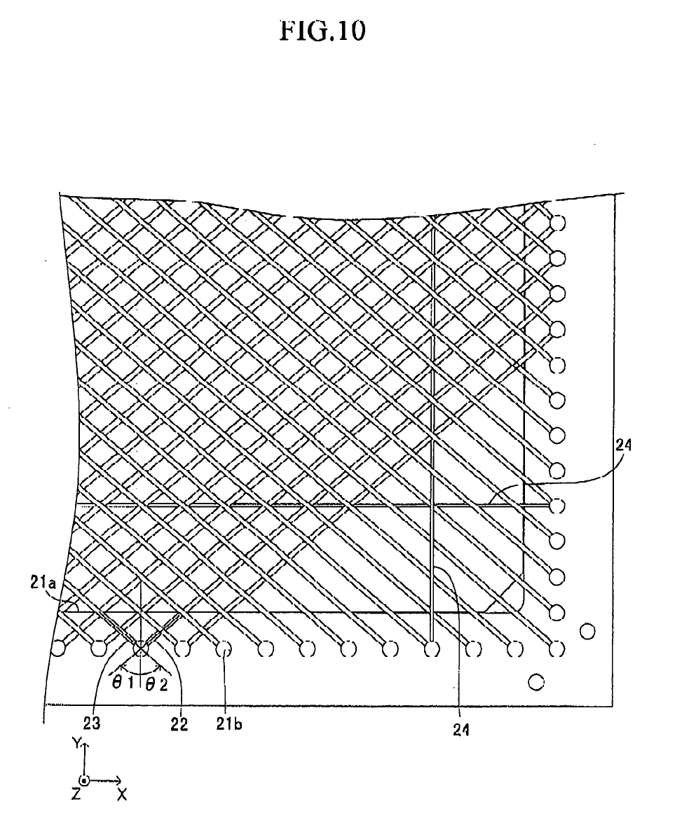

As shown in FIG. 10 that is a partially enlarged plan view, each of tile plural thread-like members 22 is held at (tied to, or engaged with) the hole 21b of the frame 21 and strained against (or tensioned to) the frame 21 so as to extend in a predetermined first direction with reference to the frame 21 (the direction having a negative angle (clockwise angle) θ1 with respect to the Y-axis positive direction) Accordingly, plural thread-like members 22 form a first plane section that is one plane section parallel to the plane (X-Y plane) formed by the frame 21.

Each of the plural thread-like members 23 is held at (tied to, or engaged with) the hole 21b of the frame 21, and strained against (or tensioned to) the frame 21 above the thread-like members 22 along a second direction (the direction having a positive (counterclockwise angle) angle θ2 with respect to the Y-axis positive direction) crossing the first direction. In this embodiment, the absolute value of the angle θ1 is equal to the absolute value of the angle θ2. Thus, the plural thread-like members 23 form a second plane section that is another plane section parallel to the first plane section formed by the plural thread-like members 22 and proximate to the first plane section above the first plane section.

Each of four thread-like members 24 is held at (tied to, or engaged with) the holes 21b of the frame 21, and arranged below (in the Z-axis negative direction) the thread-like members 22. Two tread-like members 24 are strained against (or tensioned to) the frame 21 so as to be along the Y-axis direction at the vicinity of both end portions of the rectangular opening 21a of the frame 21 in the X-axis direction. The other two thread-like members 24 are strained against (or tensioned to) the frame 21 so as to be along the X-axis direction at the vicinity of both end portions of the rectangular opening 21a of the frame 21 in the Y-axis direction.

The thread-like members 22, 23 and 24 are made of thread-like resin. The thread-like members 22, 23 and 24 are preferably made of a material that does not adhere to the to be cleaned object D, like the tray 10, even if they are brought into contact with the to-be-cleaned object D. In this embodiment, preferable materials for the thread-like members 22, 23 and 24 include polyamide(nylon)-based resin, polyester-based resin, polyurethane-based resin, polyoletin-based resin (polypropylene-based resin, polyethylene-based resin), polyvinyl-chloride-based resin, polyvinylidene-chloride-based resin, polyethylene-fluoride-based resin, polyvinyl-alcohol-based resin, polychlarl-based resin, polyacryl-based resin, and fluorine-based resin. Further, ABS resin and polycarbonate can be employed. Moreover, a material having a taper abrasion in accordance with ASTM-D1044 is not more than 300 mg/1000 times is selected for the thread-like members 22, 23 arid 24.

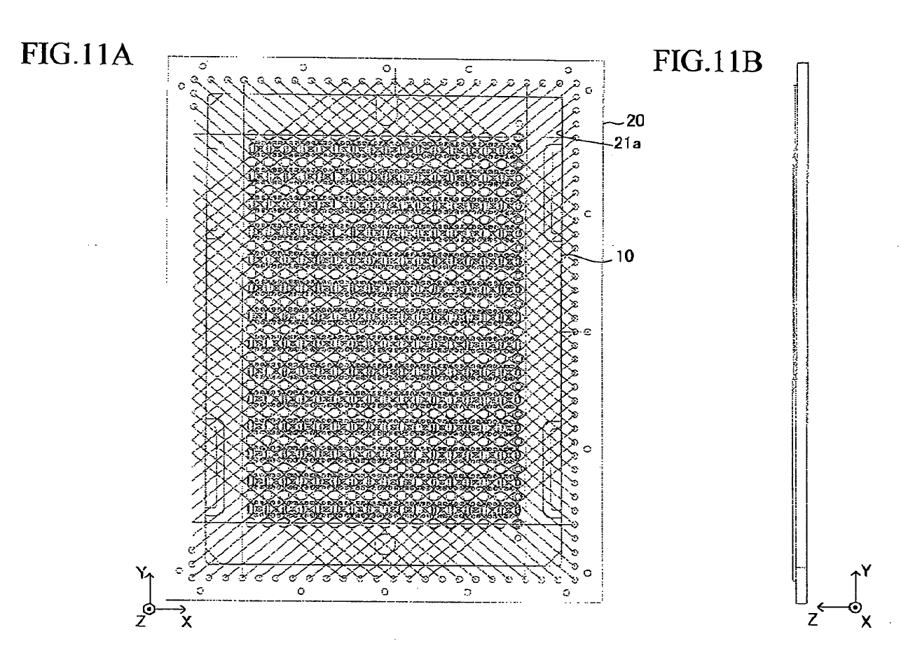

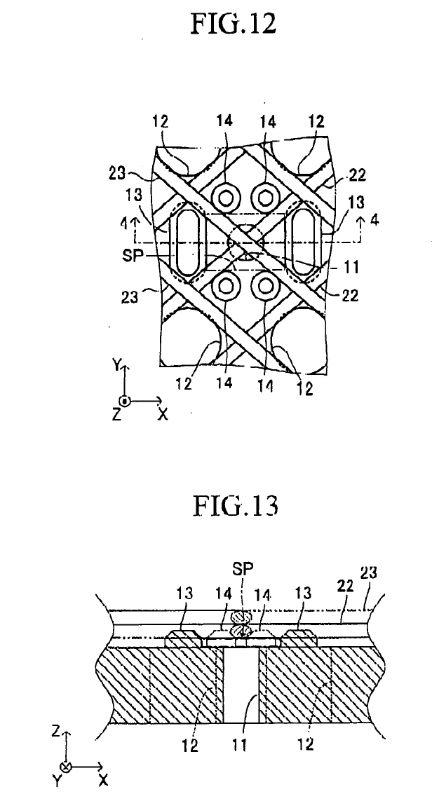

The tray 10 and the cover member 20 thus configured are overlapped with each other such that the tray 10 is accommodated in the opening 21a of the cover member 20, as shown in FIGS. 11A and 11B. Specifically, the cover member 20 is arranged above (or set on) the tray 10. In this case, the first plane section composed of the thread-like members 22 faces the upper (or top) surface of the tray 10. In other words, the first plane section composed of the thread-like members 22 is arranged between the second plane section composed of tile thread-like members 23 and the upper (or top) surface of the tray 10. The cover member 20 and the tray 10 are fixed to each other by an unillustrated clip or the like having a spring property. Accordingly, the thread-like members 22 and 23 are arranged (or placed) above each space SP of the tray 10, as shown in FIG. 12 that is a partially enlarged plan view and FIG. 13 that is a sectional view of the tray 10 and the cover member 20 cut at the plane along a line 4-4 in FIG. 12. More specifically, the thread-like members 22 and 23 pass the position immediately above the center of the small-diameter through-hole 11 and the position between the elliptic projection 13 and the circular projection 14.

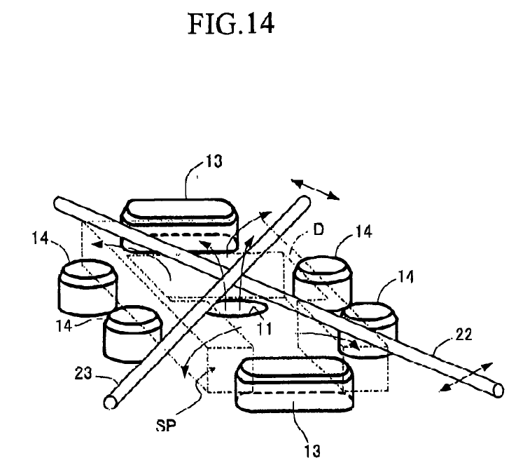

Accordingly, tile top surface of the space SP is defined by the first plane section composed of the thread-like members 22. The to-be-cleaned object D is individually accommodated in the space (to-be-cleaned object accommodating space) SP as shown in FIG. 14 that Is a perspective view, whereby the object D is dipped into cleaning solution with the cleaning tool and ultrasonic wave is applied thereto. As apparent from FIG. 14 the thread-like members 22 and 23 can be arranged to pass the position below (in the Z-axis negative direction) the top surfaces of the elliptic projection 13 and the circular projection 14.

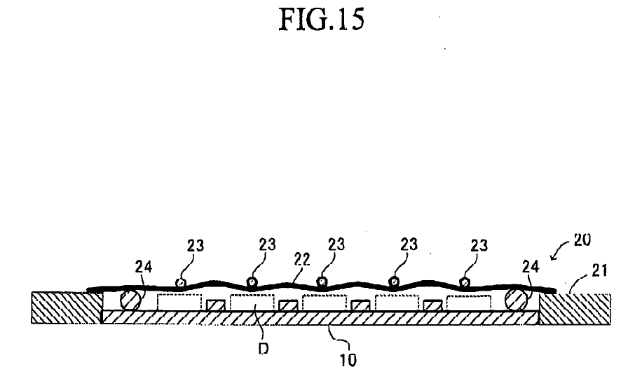

As described above, the plural thread-like members 23 composing the second plane section are arranged (or set) immediately above the plural thread-like members 22 composing the first plane section, and further arranged (or set) so as to cross the thread-like members 22 in a plan view (or seen from a plane). Therefore, as understood from FIG. 15 that schematically shows the state of the cleaning tool during the cleaning, when the thread-like members 22 are about to vibrate in the vertical direction (the direction perpendicular to the plane of the tray 10) with their both end portions (base portions of the tension) as a node, the thread-like members 23 hold down the thread-like members 22 so as to restrict the vibration of the thread-like members 22. As a result, the possibility that the to-be-cleaned object D comes out of the to-be-cleaned object accommodating space and falls off from the cleaning tool can be reduced.

On the other hand, since the thread-like members 23 are arranged above the thread-like members 22 (in other words, the thread-like members 22 and thread-like members 23 are not braided), the movement of the thread-like members 22 in the plane (X-Y plane) parallel to the first plane section is not restricted. Therefore, the thread-like members 22 can move in the plans parallel to the first plane section when the cleaning solution comes into or out of the to-be-cleaned object accommodating space, whereby they do not prevent the cleaning solution (or ultrasonic wave) from reaching the to-be-cleaned object D.

Similarly, the thread-like members 22 are arranged below the thread-like members 23, so that the thread-like members 22 do not restrict the movement of the thread-like members 23 in the plane (X-Y plane) parallel to the second plane section. Therefore, the thread-like members 23 can move in the plane parallel to the second plane section when the cleaning solution comes into or out of the to-be-cleaned object accommodating space, whereby they do not prevent the cleaning solution (or ultrasonic wave) from reaching the to-be-cleaned object D.

Consequently, the possibility of the arrival of the cleaning solution (or ultrasonic wave) to the whole surface of the to-be-cleaned object D is increased, so that the to-be-cleaned object D can sufficiently be cleaned.

In addition, when the cover member 20 is placed on the tray 10, the thread-like members 24 are placed (or arranged) between the top surface of the portion composing the lower portion (bottom portion) of the to-be-cleaned object accommodating space of the tray 10 and the lower surface of the first plane section (i.e., the thread-like member 22). Accordingly, the thread-like members 24 can maintain the gap (the height of the to-be-cleaned object accommodating space) between the top surface to the portion composing the lower portion of the to-be-cleaned object accommodating space and the lower surface of the first plane section, as shown in FIG. 15.

Accordingly, the cleaning tool according to the first embodiment can easily change the height of the to-be-cleaned object accommodating space only by replacing the thread-like members 24 with another thread-like members having different diameters. As a result, a cleaning member (or a cleaning tool) that can be used for to-be-cleaned members having various heights can easily be provided without charging the shapes of the tray 10 and the cover member 20.

### Second Embodiment

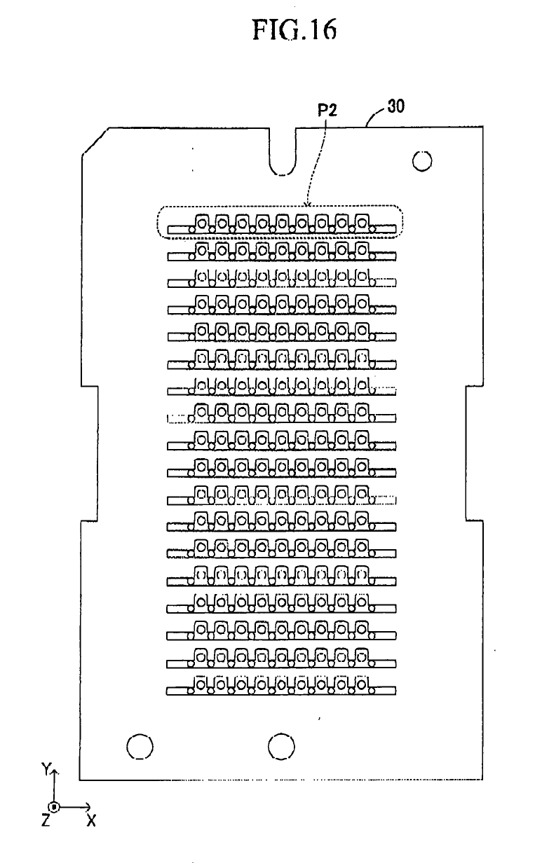

Subsequently, a cleaning tool according to a second embodiment of the present invention will be explained. The cleaning tool according to the second embodiment is composed of a tray 30 shown in FIGS. 16 to 18 and a cover member 40 shown in FIGS. 10 to 23.

The tray 30 is made of a material same as that of the tray 10. As shown in FIG. 16 that is a plan view of the front surface of the tray 30, the tray 30 is a generally rectangular thin plate member, in a plan view (or seen from a plane), having sides along an X-axis and sides along a Y-axis, both axes being orthogonal to each other, Patterns P2 encircled by a broken line in FIG. 10 are repeatedly formed at the tray 30 along the Y-axis direction.

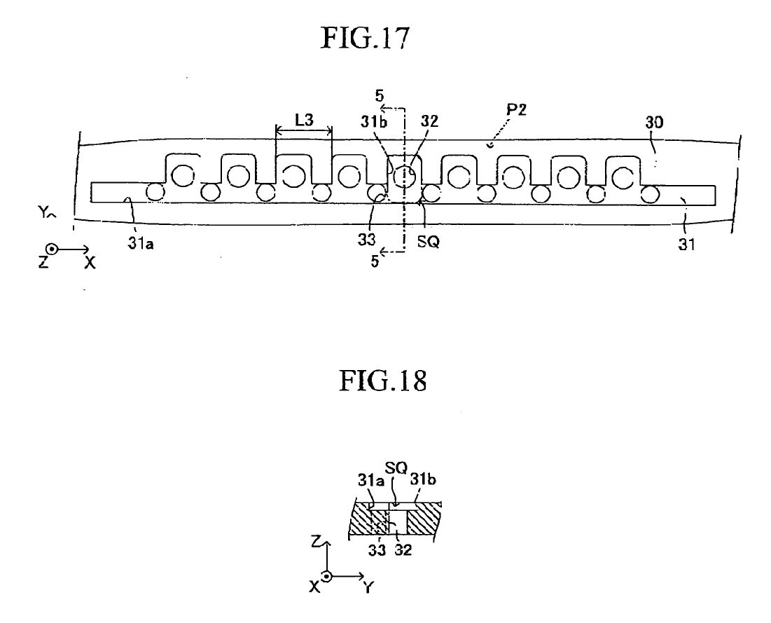

As shown in FIG. 17 and FIG. 18 that is a sectional view of the tray 30 cut at the plane along a line 5-5 in FIG. 17, the pattern P2 is composed of a recess portion 31 having a constant depth, large-diameter through-holes 32, and small-diameter through-holes 33.

The recess portion 31 is composed of a recess portion 31a and plural recess portions 31b. The shape of the recess portion 31a in a plan view (or seen from a plane) is a narrow belt-like shape having a narrow width in the Y-axis direction and having a longitudinal direction in the X-axis direction. The shape of each recess portion 31b in a plan view (or seen from a plane) is generally a square. The recess portions 31b are formed at every predetermined distance L3 along the X.-axis direction, The end portion of each recess portion 31b in the Y-axis negative direction communicates with the recess portion 31a. Each recess portion 31b and the portion of the cross portion 31a communicating with the recess portion 31b form a space SQ, which has a shape of generally rectangular solid and whose top surface is open, The space SQ is for accommodating the to-be-cleaned object.

Each of the large-diameter through-holes 32 is formed at generally the center of the recess portion 31b (the bottom surface of the space SQ). Each of the small-diameter through-holes 33 is formed between the adjacent recess portions 31b at the recess portion 31a.

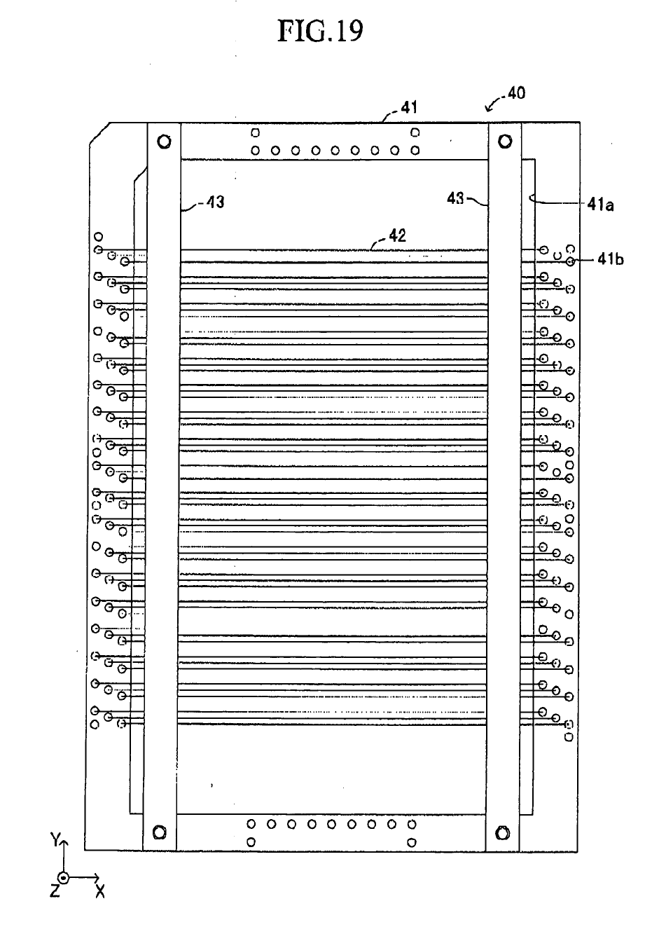

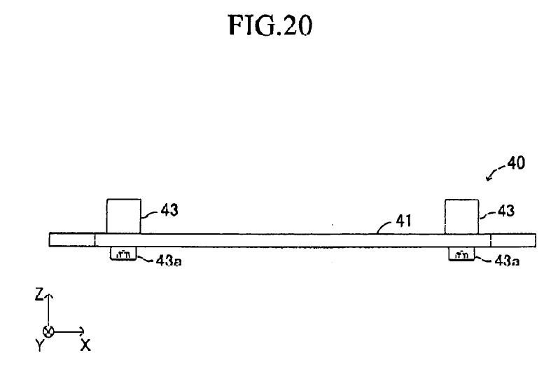

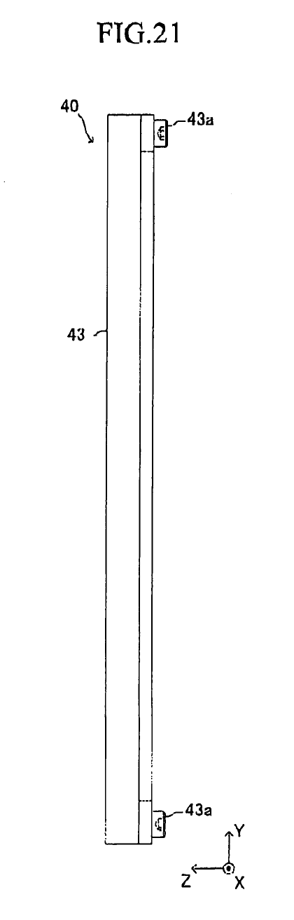

The cover member 40 is composed of a metallic frame 41, plural thread-like members 42 and a pair of bar-like members 43 as shown in FIG. 19 that is a plan view, FIG. 20 that is a front view, and FIG. 21 that is a side view.

The frame 41 is a thin plate member having a rectangular outer shape in a plan view (or seen from a plane). The minor sides and major sides of this rectangle are respectively along the X-axis and Y-axis. An opening (window) 41a which is slightly greater than the outer shape of the tray 30 is formed at the frame 41. Further, plural holes 41b for holding (or tying) the thread-like members 42 are formed at the frame 41.

The thread-like members 42 are made of the material same as those of the thread-like members 22, 23 and 24. Each of the thread-like members 42 is held at (tied to, or engaged with) the hole 41b of the frame 41 and arranged along a predetermined first direction (here, the X-axis direction). Therefore, the plural thread-like members 42 form a first plane section that is one plane section parallel to the plane (X-Y plane) formed by the frame 41.

Each of the bar-like members 43 has a shape of slender square pole. Each of the bar-like members 43 is fixed to the top surface of the frame 41 so as to pass above tile thread-like members 42. Each of the bar-like members 43 is arranged at the position in the vicinity of both end portions of the frame 41 in the X-axis direction and slightly closer to the center from the portion of the frame 41 extending along the Y-axis direction. As shown in FIGS. 20 and 21, each of the bar-like members 43 is tightly fixed to the frame 41 (more specifically, the portion of the frame extending in the X-axis direction) by a screw 43a that penetrates the frame 41 from the bottom portion of the frame 41. In this case, the lower surface of the bar-like member 43 is positioned below the top surface of the frame 41 at the opening 41a (e.g., the lower surface of the bar-like member 43 at the central portion protrudes higher than the lower surface of the bar-like member 43 at its both end portions).

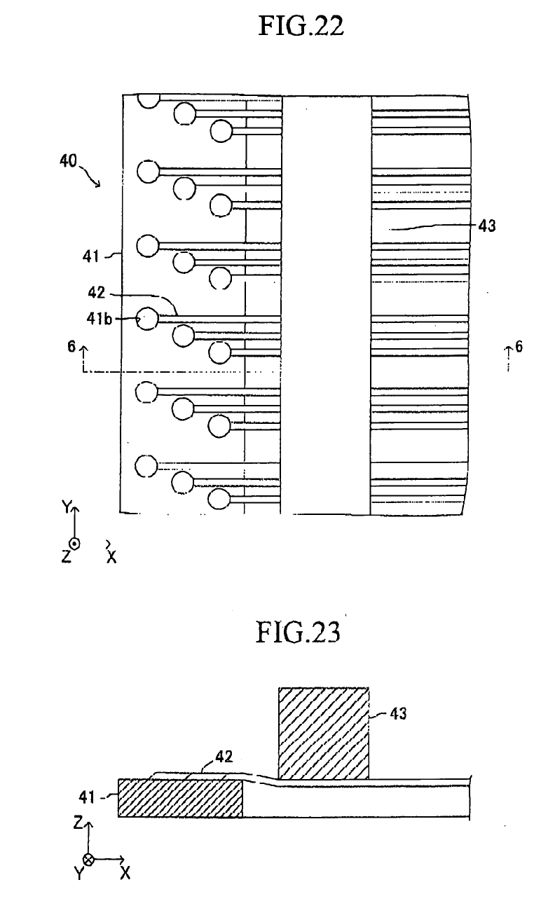

With this configuration, the bar-like members 43 move the thread-like members 42 downward at the contact portion of the bar-like members 43 and the thread-like members 42 as shown in FIG. 22 that is a partially enlarged plan view of the cover member 40 and FIG. 23 that is a sectional view of the cover member 40 cut at the plane along a line 6-6 in FIG. 22. Specifically, the bar-like members 43 are fixed to the frame 41 so as to extend in a second direction that is parallel to the first plane section and that crosses the first direction above the first plane section and at least in the vicinity of both end portions of the thread-like members 42. Accordingly, the bar-like members 43 are brought Into contact with the thread like members 42 to apply thereto force in the direction orthogonal to the first plane section (e.g., the force in the direction crossing the first plane section, i.e., the force in the Z-axis negative direction that is orthogonal to the X-Y plane formed by the frame), thereby applying tension to the thread-like members 42.

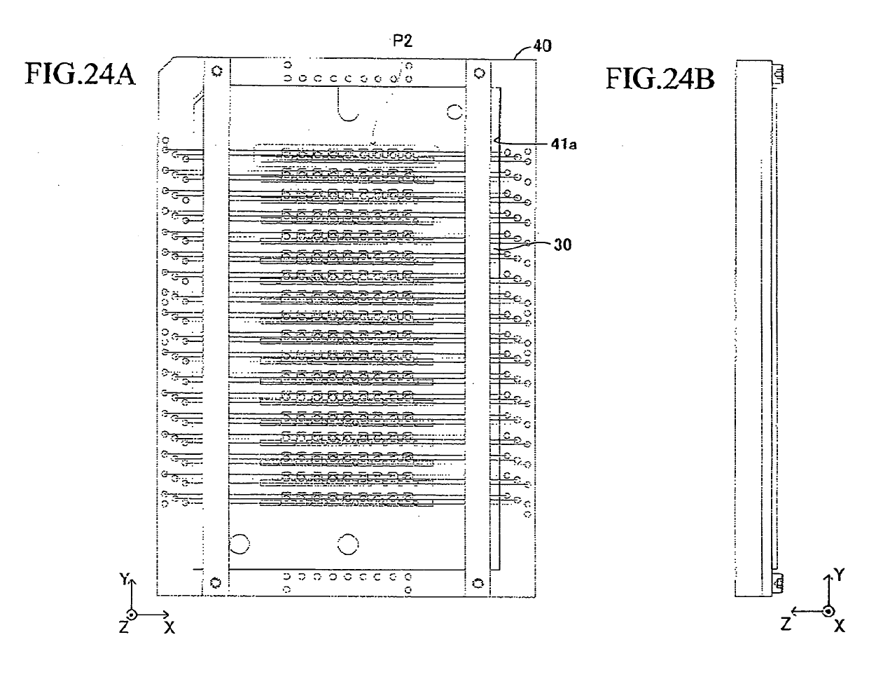

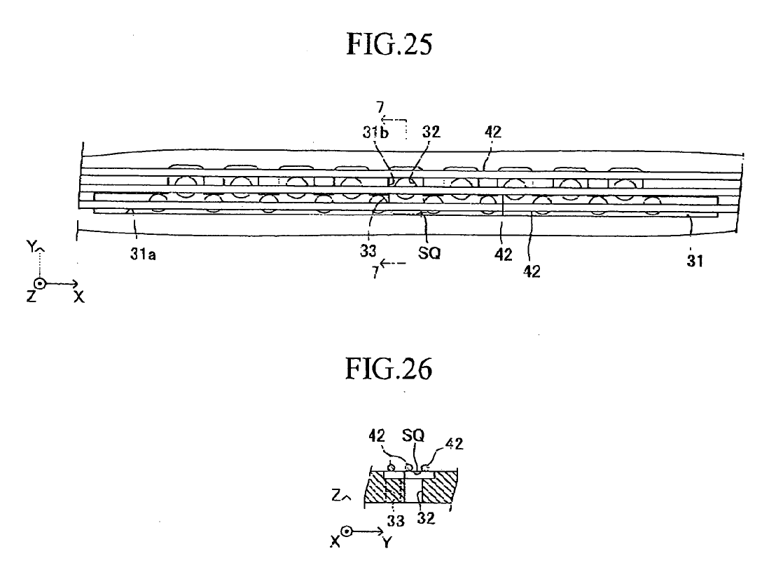

The tray 30 and the cover member 40 thus configured are overlapped with each other such that the tray 30 is accommodated into the opening 41a of the cover member 40 as shown in FIGS. 24A and 24B. Specifically, the cover member 40 is set on (or arranged above) the tray 30. The cover member 40 and the tray 30 are fixed to each other by an unillustrated clip or the like having a spring property. Accordingly, three thread-like members 42 are placed (or arranged) above each space SQ of the tray 30, as shown in FIG. 25 that is a partially enlarged plan view, and FIG. 26 that is a sectional view of the tray 30 and the cover member 40 cut at the plane along a line 7-7 in FIG. 25. More specifically, three thread-like members 42 make one set, and pass above a single recess portion 31. Among three thread-like members 42, the first thread-like member 42 passes above the recess portion 31a, the second thread-like member 42 passes above the large-diameter through-holes 32, and the third thread-like member 42 passes above the portions between the end portions of the recess portions 31b in the Y-axis direction and the large-diameter through-holes 32.

Thus, the top surface of the space SQ is defined by the first plane section formed by the thread-like members 42. The to-be-cleaned object D is individually accommodated in this space (to-be-cleaned object accommodating space) SQ, and then, the to-be-cleaned object D is dipped into cleaning solution with the cleaning tool, and ultrasonic wave is applied thereto.

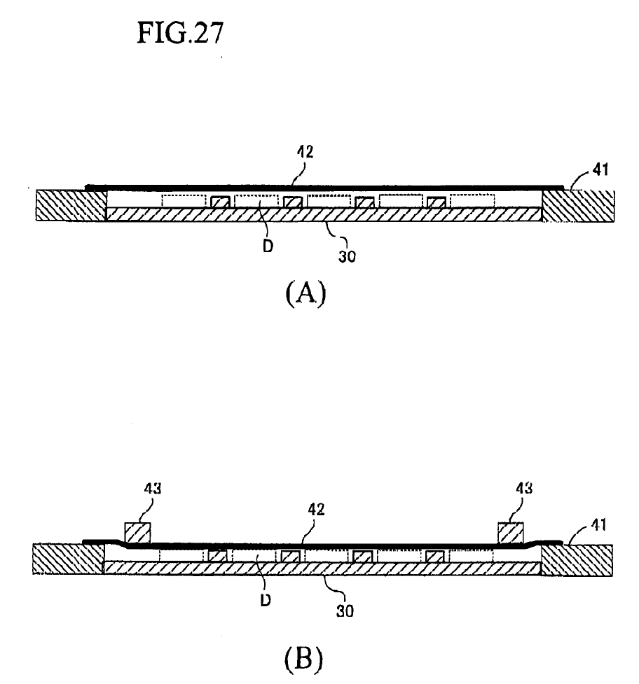

According to this second embodiment, even If appropriate tension is not applied to the thread-like members 42 when the thread-like members 42 forming the first plane section are attached to the frame 41 (see (A) of FIG. 27), appropriate tension can easily be applied to the thread-like members 42 forming the first plane section by adjusting the position of the bar-like members 43 to the frame 41 (see (B) of FIG. 27). Accordingly, the work operation for forming (or making) the cover member 40 can be simplified. Further, tension can surely be applied to the thread-like members 42, so that the vibration of the thread-like members 42 during the cleaning can be restricted.

It is to be noted that the frame 41 (cover member 40) may have not only the thread-like members 42 composing the first plane section but also the above-mentioned thread-like members composing the second plane section. With this configuration, the bar-like members 43 exert force in the direction crossing the first plane section on the thread-like members 42 forming the first plane section and on the thread-like members forming the second plane section, with the result that the bar-like members 43 can apply tension to the thread-like members 42 forming the first plane section and the thread-like members forming the second plane section.

Moreover, the bar-like members 43 may be configured such that the position of the bar-like members 43 to the frame 41 in the direction orthogonal to the plane made by the frame can be adjusted, and further configured to be supporters and fixed to the frame 41 at the adjusted position in this case, the position of the lower surface of each bar-like member 43 can be changed in accordance with the screwing amount of the screw 43a.

### Modified Example of Second Embodiment

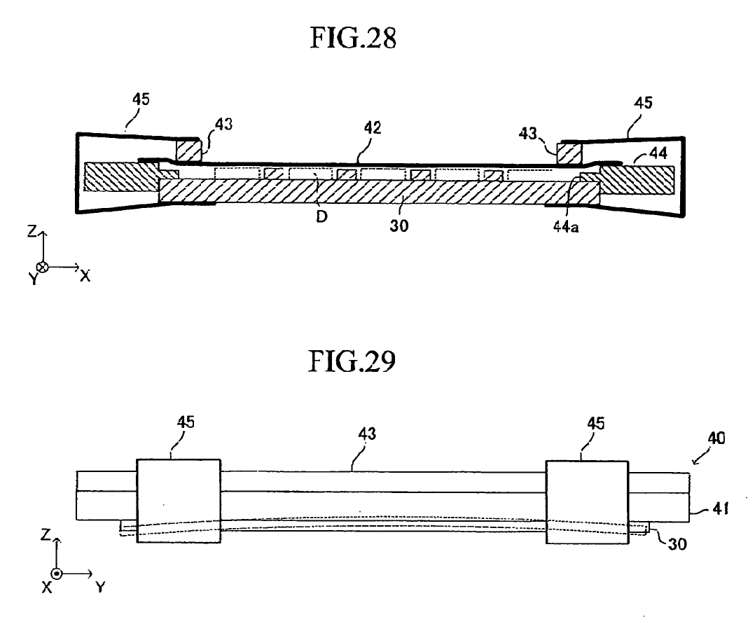

As shown in FIG. 28, this modified example has a frame 44, instead of the frame 41 of the cleaning tool according to the second embodiment, and further has spring-like members 45 having a section of the Japanese letter “ [symbol] ” which is generally a reversed C-letter shape.

The frame 44 is different from the frame 41 only in that it has projections 44a projecting from the inner periphery. The tray 30 comes in contact with the projections 44a at its peripheral edge portion when the cover member (frame 44) is arranged above the tray.

The spring-like members 45 have spring property, Each of them is engaged with (in contact with) the top surface of the bar-like member 43 and the lower surface of the tray 30 for exert force in the direction in which the bar-like member 43 and the tray 30 are made closer to each other. Four spring-like members 45 are prepared, and they are arranged in the vicinity of the four corner portions of the cleaning tool.

With this configuration, even if a warp is caused in the tray 30 as shown by a broken line in FIG. 20, the warp can be corrected by the bar-like members 43 or which the warp is difficult to be caused and by the spring-like members 45. Therefore, the cleaning tool having the to-be-cleaned object accommodating space which has an aimed size and an aimed shape can be provided.

It is to be noted that a wall portion (rib) that is upright in the Z-axis direction may be formed at the peripheral section of the tray 30, and the relative position of the tray 30 to the frame 44 may be fixed by bringing the top surface of the wall portion in contact with the lower surface of the thread-like members 42 immediately below the bar-like members 43. In this case, the frame 44 does not need the projections 44a.

### Third Embodiment

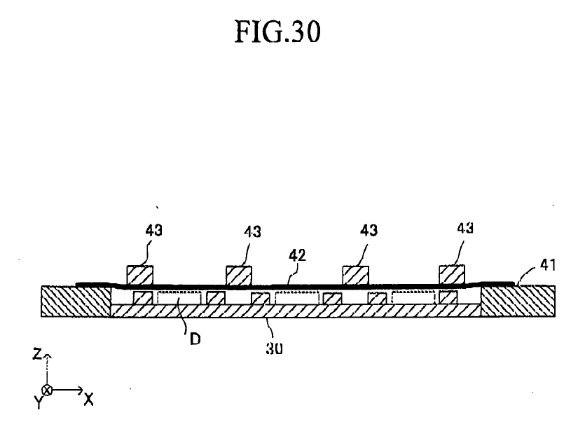

Subsequently, a cleaning tool according to a third embodiment of the present invention will be explained with reference to FIG. 30. The cleaning tool according to the third embodiment is different from the cleaning tool according to the second embodiment only in that three or more bar-like members 43 (four in the example in FIG. 30) are provided. All of the bar-like members 43 are supported and fixed to the frame 41 at predetermined intervals so as to have a longitudinal direction in the Y axis direction, like the bar-like members 43 in the second embodiment. Further, the position of each of the bar-like members 43 is adjusted such that each lower surface is arranged (or positioned) on the same plane. In addition, the tray 30 is configured such that the accommodating space for the to-be-cleaned object D is not formed immediately below each of the bar-like members 43,

With this configuration, tension can be applied to the thread-like members 42 by the bar-like members 43, like the second embodiment. Further, the lower surface of each of the bar-like members 43 forms (or composes) a second plane above the first plane formed by the thread-like members 42. Therefore, the movement of the thread-like members 42 in the first plane is not restricted by the bar-like members 43, while the movement of the thread-like members 42 in the direction perpendicular to the first plane is restricted by the bar-like members 43. As a result, the possibility of the arrival of the cleaning solution (or ultrasonic wave) to the whole surface of the to-be-cleaned object D is increased, so that the to-be-cleaned object D can sufficiently be cleaned.

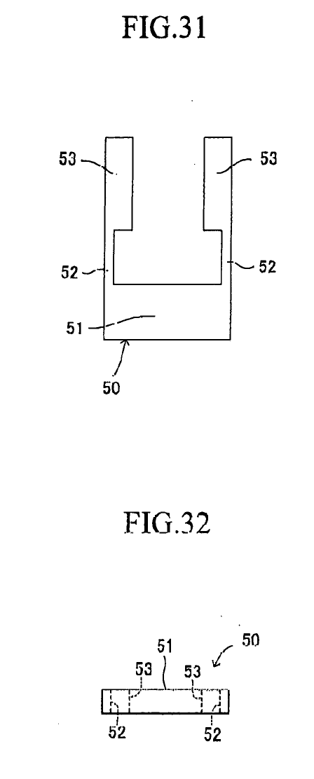

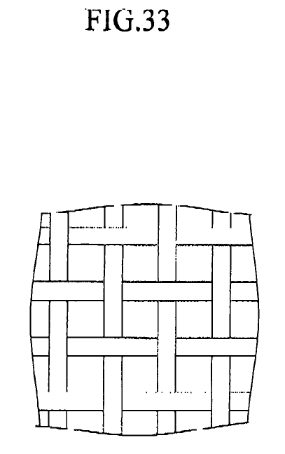

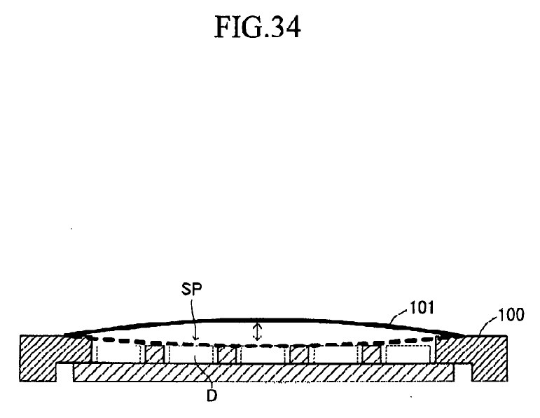

It is to be noted that the to-be-cleaned object D is, for example, a device 50 that functions as an actuator for controlling the position of a reading and/or writing device (head) of optical information or magnetic information as shown in FIGS. 31 and 32. This device 50 has a fixing section 51, a pair of thin plate sections 52 supported by the fixing section 51, holding sections (movable sections) 53 provided at the leading end of each of the thin plate portions 52 for holding the object, and piezoelectric/electrostriction device (not shown) formed on the thin plate portions 52. The piezoelectric/electrostriction device has plural electrodes and plural piezoelectric/electrostriction layers that are alternately laminated. The outer shape of the device 50 is generally a rectangular solid. The device 50 is made of ceramics. It makes the thin plate portions 52 deform by the expansion and contraction of the piezoelectric/electrostriction device through the formation of electric fields between the electrodes of the piezoelectric/electrostriction device, by which the holding portions 53 (accordingly, the heads held by the holding sections 53) are displaced.

The device 50 described above is formed by cutting, by a wire saw or the like, an integrated member of ceramics that were burned after the lamination. Therefore, it is preferable that the resin or powders adhered to the device during the manufacturing process such as the cutting process are surely washed away by ultrasonic cleaning while it is dipped into cleaning solution in a cleaning tank with the cleaning tool in a state in which it is accommodated in the to-be-cleaned object accommodating space of the cleaning tool of the present invention.

The number and diameter (thickness) of the thread-like members used in the cleaning tool of the present invention are selected such that the device 50 does not fall off from the to-be-cleaned object accommodating space during not only the cleaning but also the transportation, for example. Further, the number and diameter (thickness) of the thread-like members are selected such that the cleaning solution (or ultrasonic wave) spreads all over the whole surface of the device 50 and the particles present in the to-be-cleaned object accommodating space can be eliminated (or carried) to the outside of the to-be-cleaned object accommodating space by the flow of the cleaning solution without causing the cleaning solution to stay in the to be-cleaned object accommodating space.

As explained above, the cleaning tool according to the present invention can satisfactorily clean the to-be-cleaned object. The present invention is not limited to the aforesaid each embodiment, and various modification are possible without departing from the spirit of the present invention, Further, what is required for the second direction is that it crosses the first direction seen from a plane, thus, for example, it is unnecessary that all of the thread-like members 23 are parallel to one another in the X-Y plane.

What is claimed is:

1. A cleaning tool comprising:
a tray having and forming a space for individually accommodating a to-be-cleaned object, wherein at least the top portion of tile space is open; and
a cover member including a frame, a first plane section made of plural thread-like members that are strained against the frame along a predetermined first direction so as to form one plane section, a second plane section made of plural thread-like members that are strained against the frame along a second direction crossing the first direction so as to form another plane section that is parallel to the first plane section and is proximate to the first plane section above the first plane section or a second plane section made of bar-like members supported by the frame along the second direction crossing the first direction so as to form the same another plane section, wherein the first plane section defines the top surface of the space when the cover member is set on the tray,
wherein the cleaning tool is dipped into cleaning solution with the to-be-cleaned object accommodated in the space.

2. A cleaning tool according to claim 1, further comprising:
plural thread-like members that are placed between the top surface of the portion forming the lower section of the space of the tray and the lower surface of the first plane section of the cover member for maintaining the gap between the top surface of the portion forming the lower section of the space and the lower surface of the first plane section.

3. A cleaning tool comprising:
a tray having and forming a space for individually accommodating a to-be-cleaned object, wherein at least the top portion of the space is open; and
a cover member including a frame, and a first plane section made of plural thread-like members that are strained against the frame along a predetermined first direction so as to form one plane section, wherein the first plane section defines the top portion of the space when the cover member is set on the tray;
the cleaning tool being dipped into cleaning solution with the to-be-cleaned object accommodated in the space,
wherein the cover member comprises a bar-like member fixed to the frame so as to extend in a second direction that Is parallel to the first plane section and that crosses the first direction above the first plane section and at least in the vicinity of both end potions of the thread-like member, the bar-like member being brought into contact with the thread-like members to apply thereto force in the direction crossing the first plane section for applying tension to the thread-like members.

4. A cleaning tool according to claim 3, further comprising:
a spring-like member that is engaged with both the bar-like member and the tray when the cover member is set on the tray, the spring-like member exerting force in the direction in which the bar-like member and the tray are made closer to each other.
